(19) United States
(12) Patent Application Publication
(10) Pub. No.: US 2022/0063358 A1
(43) Pub. Date: Mar. 3, 2022

(54) Drawbar Tow Hitch Assembly

(71) Applicant: Phillip Evans, Joshua, TX (US)

(72) Inventor: Phillip Evans, Joshua, TX (US)

(21) Appl. No.: 17/008,800

(22) Filed: Sep. 1, 2020

(51) Int. Cl. B60D 1/06; B60D 1/145; B60D 1/28; B60D 1/14; B60D 1/36

(52) U.S. Cl. CPC B60D 1/065; B60D 1/145; B60D 1/36; B60D 1/143; B60D 1/28

(57) ABSTRACT

A drawbar tow hitch assembly for towing a trailer with a ball hitch using a tractor includes a tube that has a passageway extending for having a drawbar of a tractor extended therethrough. A pin is extendable through the tube to engage the drawbar for attaching the tube to the drawbar. A tow ball is removably attached to the tube to facilitate the tractor to tow a trailer with a ball hitch when the tube is positioned on the drawbar. A plurality of nuts is each attached to the tube. A pair of eyebolts is provided and a respective one of the eyebolts is adjustably attachable to the plurality of nuts to engage a tow point on the tractor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tow hitch devices and more particularly pertains to a new tow hitch device for towing a trailer with a ball hitch using a tractor.

### (2) Description of Related Art Including Information Disclosed Under 37 CFR 1.97 and 1.98

The prior art relates to tow hitch devices including a trailer hitch that includes a tension spring for stabilizing a trailer on a tractor. The prior art discloses a triangular frame that is attachable to a tractor and that can insertably receive a tow hitch for towing with the tractor. The prior art also discloses a triangular frame that is attachable to a tractor and which has a tow point thereon. The prior art discloses a hitch device that attaches to a three point hitch on a tractor to facilitate towing a gooseneck trailer. The prior art discloses a support structure for a towing ball that is attachable to a vehicle. Additionally, the prior art discloses a hitch device that includes an arcuate member that is attachable to a three point hitch on a tractor for towing a gooseneck trailer.

### Brief Summary of the Invention

An embodiment of the disclosure meets the needs presented above by generally comprising a tube that has a passageway extending for having a drawbar of a tractor extended therethrough. A pin is extendable through the tube to engage the drawbar for attaching the tube to the drawbar. A tow ball is removably attached to the tube to facilitate the tractor to tow a trailer with a ball hitch when the tube is positioned on the drawbar. A plurality of nuts is each attached to the tube. A pair of eyebolts is provided and a respective one of the eyebolts is adjustably attachable to the plurality of nuts to engage a tow point on the tractor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a drawbar tow hitch assembly according to an embodiment of the disclosure.

FIG. 2 is a front view of an embodiment of the disclosure.

FIG. 3 is a back view of an embodiment of the disclosure.

FIG. 4 is a bottom view of an embodiment of the disclosure.

FIG. 5 is a top in-use view of an embodiment of the disclosure.

FIG. 6 is a perspective in-use view of an embodiment of the disclosure.

FIG. 7 is a right side exploded view of an embodiment of the disclosure.

### DETAILED DESCRIPTION OF THE INVENTION

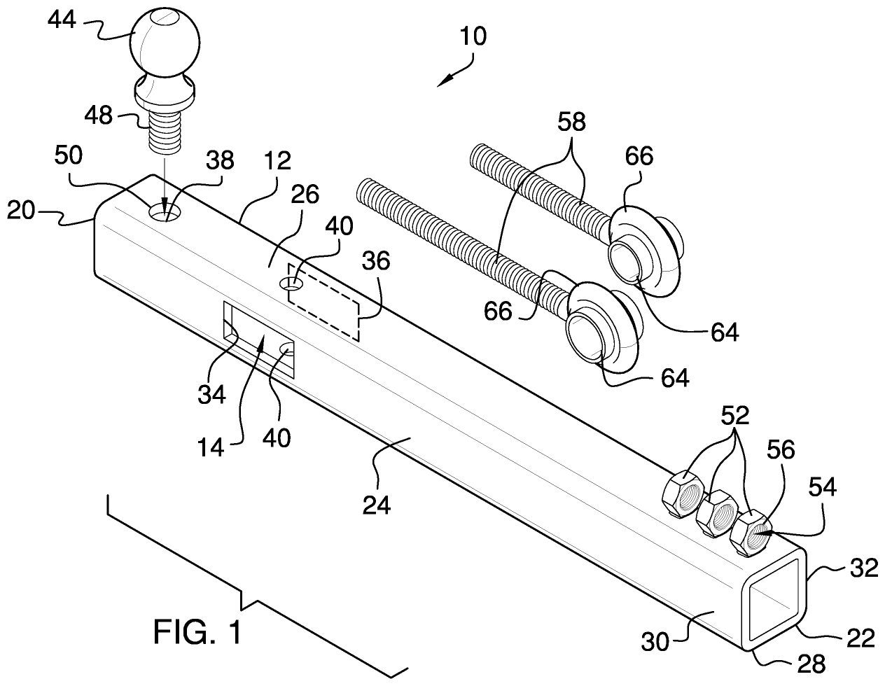

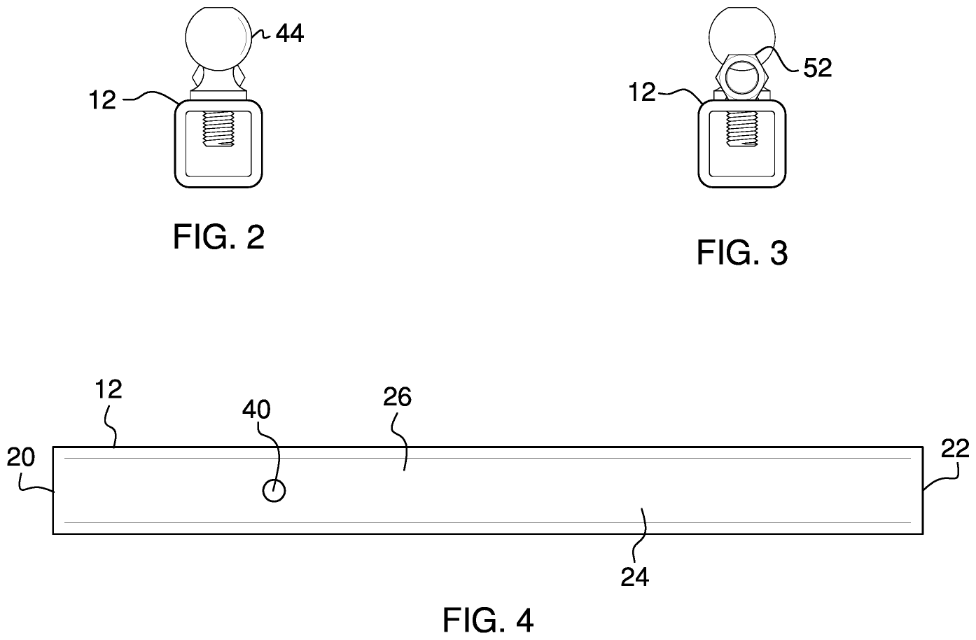

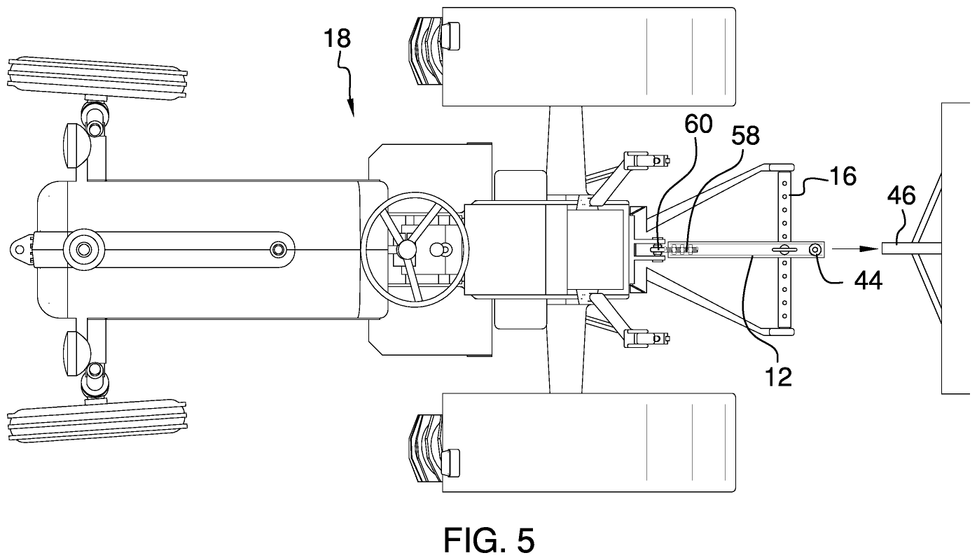

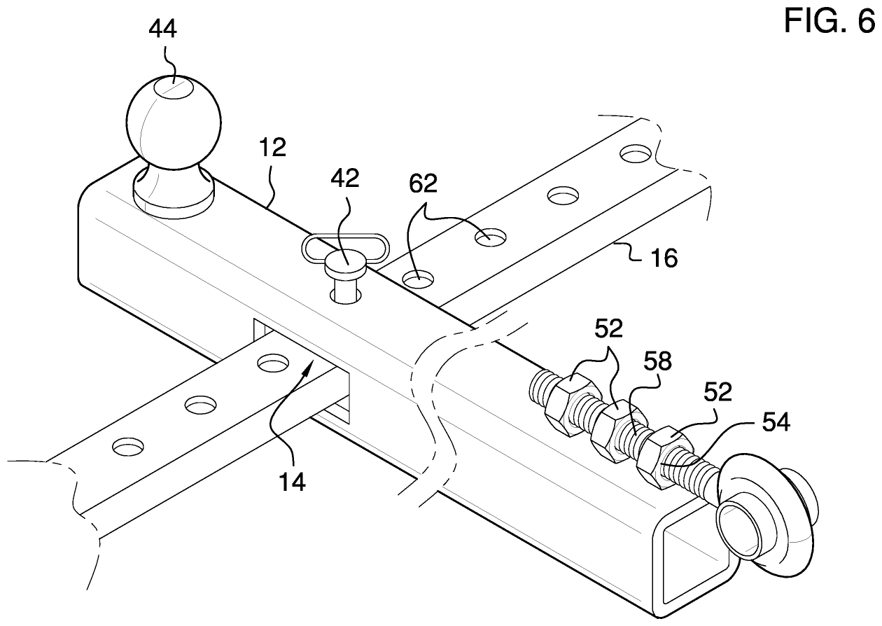

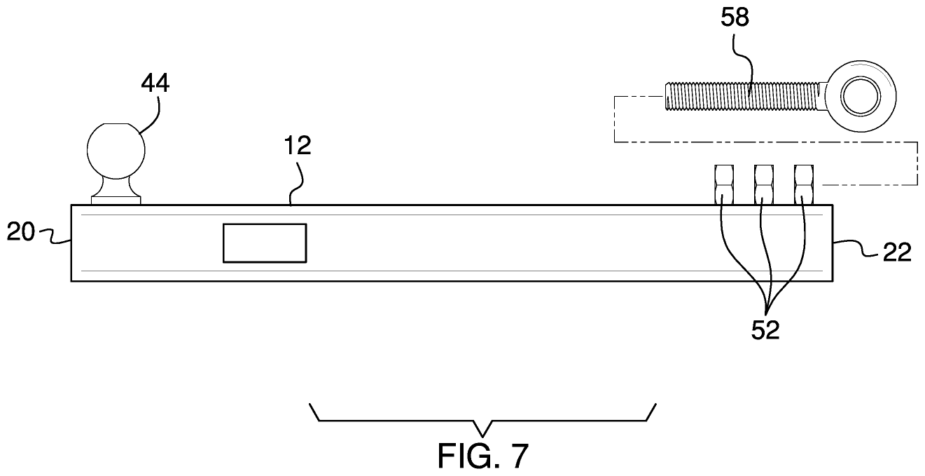

With reference now to the drawings, and in particular to FIGS. 1 through 7 thereof, a new tow hitch device embodying the principles and concepts of an embodiment of the disclosure and generally designated by the reference numeral 10 will be described.

As best illustrated in FIGS. 1 through 7, the drawbar tow hitch assembly 10 generally comprises a tube 12 that has a passageway 14 extending therethrough for having a drawbar 16 of a tractor 18 extended therethrough. The tractor 18 may be a farm tractor of any conventional design or any other motorized vehicle that has a drawbar and a tow point. The tube 12 has a first end 20, a second end 22 and an outer wall 24 extending therethrough, and the outer wall 24 has a top side 26, a bottom side 28, a first lateral side 30 and a second lateral side 32. The first lateral side 30 has a first opening 34 extending therethrough and the second lateral side 32 has a second opening 36 extending therethrough. The first opening 34 is aligned with the second opening 36 to define the passageway 14, and each of the first opening 34 and the second opening 36 is positioned closer to the first end 20 than the second end 22.

The top side 26 has a hole 38 extending therethrough and the hole 38 is positioned between the passageway 14 and the first end 20. The tube 12 has a pair of apertures 40 each extending through a respective one of the top side 26 and the bottom side 28. The apertures 40 are aligned with each other and each of the apertures 40 is aligned with the first opening 34 and the second opening 36. In this way each of the apertures 40 can be aligned with the drawbar 16 when the drawbar 16 is extended through the passageway 14.

A pin 42 is provided and the pin 42 is extendable through the tube 12 to engage the drawbar 16 for attaching the tube 12 to the drawbar 16. The pin 42 is extendable through each of the apertures 40 in the top side 26 and the bottom side 28 of the outer wall 24. A tow ball 44 is removably attached to the tube 12 to facilitate the tractor 18 to tow a trailer 46 with a ball hitch when the tube 12 is positioned on the drawbar 16. The tow ball 44 includes a screw 48 that threadably engages a bounding edge 50 of the hole 38 in the top side 26 of the outer wall 24 of the tube 12.

A plurality of nuts 52 is provided and each of the nuts 52 is attached to the tube 12. The nuts 52 are aligned with each other on the tube 12 and each of the nuts 52 is positioned on the top side 26 of the outer wall 24 of the tube 12. The nuts 52 are spaced apart from each other and are distributed from the second end 22 toward the first end 20. Each of the nuts 52 has an aperture 54 extending therethrough, the aperture 54 in each of the nuts 52 has a bounding edge 56 and the bounding edge 56 is threaded. The nuts 52 are oriented such that an axis extending through the first end 20 and the second end 22 of the tube 12 is aligned with an axis extending through the aperture 54 in each of the nuts 52.

A pair of eyebolts 58 is provided and a respective one of the eyebolts 58 is adjustably attachable to the plurality of nuts 52. In this way the respective eyebolt 58 can engage a tow point 60 on the tractor 18. The respective eyebolt 58 is movable toward or away from the tow ball 44 when the respective eyebolt 58 is adjusted in the nuts 52. In this way the respective eyebolt 58 can align each of the apertures 40 in outer wall 24 of the tube 12 with a respective pin hole 62 in the drawbar 16 thereby facilitating the pin 42 to extend through the respective pin hole 62. Each of the eyebolts 58 comprises a universal joint 64 being integrated into an eye 66 of the eyebolt 58. The respective eyebolt 58 threadably engages the bounding edge 56 of the aperture 54 in each of the nuts 52 thereby facilitating the universal joint 64 to pivotally engage the tow point 60. In this way the pin 42 and the respective eyebolt 58 securely fastens the tube 12 to the tractor 18 for towing. Additionally, the universal joint 64 in each eyebolt 58 may have a unique diameter with respect to each other for accommodating various sizes of tow points 60.

In use, the drawbar 16 is extended through the passageway 14 in the tube 12 and the pin 42 is extended through the tube 12 to engage the drawbar 16. The respective eyebolt 58 is threaded into the nuts 52 and adjusted until the universal joint 64 is aligned with the tow point 60. The tow ball 44 is attached the tube 12 thereby facilitating a trailer 46 with a ball hitch to be attached to the tow ball 44. In this way the tractor 18 can tow the trailer 46 in a pasture, feed lot or other location that would pose challenges for a more traditional tow vehicle such as a pickup truck. Moreover, the tractor 18 can more easily maneuver the trailer 46 than a more traditional tow vehicle, thereby facilitating the trailer 46 to be precisely maneuvered.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drawbar tow hitch assembly for attaching a tow ball to a draw bar of a tractor, said assembly comprising:
a tube having a passageway extending therethrough wherein said passageway is configured to have a drawbar of a tractor extended therethrough;
a pin being extendable through said tube wherein said pin is configured to engage the drawbar for attaching said tube to the drawbar;
a tow ball being removably attached to said tube wherein said tow ball is configured to facilitate the tractor to tow a trailer with a ball hitch when said tube is positioned on the drawbar;
a plurality of nuts, each of said nuts being attached to said tube, said nuts being aligned with each other on said tube; and
a pair of eyebolts, a respective one of said eyebolts being adjustably attachable to said plurality of nuts wherein said respective eyebolt is configured to engage a tow point on the tractor.

2. The assembly according to claim 1, wherein said tube has a first end, a second end and an outer wall extending therethrough, said outer wall having a top side, a bottom side, a first lateral side and a second lateral side, said first lateral side having a first opening extending therethrough, said second lateral side having a second opening extending therethrough, said first opening being aligned with said second opening to define said passageway, each of said first opening and said second opening being positioned closer to said first end than said second end.

3. The assembly according to claim 2, wherein:
said top side has a hole extending therethrough, said hole being positioned between said passageway and said first end; and
said tow ball includes a screw that threadably engages a bounding edge of said hole.

4. The assembly according to claim 2, wherein said tube has a pair of apertures each extending through a respective one of said top side and said bottom side, said apertures being aligned with each other, each of said apertures being aligned with said first opening and said second opening wherein each of said apertures is configured to be aligned with the drawbar when the drawbar is extended through said passageway.

5. The assembly according to claim 4, wherein said pin is extendable through each of said apertures in said top side and said bottom side of said outer wall.

6. The assembly according to claim 2, wherein each of said nuts is positioned on said top side of said outer wall of said tube, said nuts being spaced apart from each other and being distributed from said second end toward said first end.

7. The assembly according to claim 2, wherein each of said nuts has an aperture extending therethrough, said aperture in each of said nuts having a bounding edge, said bounding edge being threaded, said nuts being oriented such that an axis extending through said first end and said second end of said tube is aligned with an axis extending through said aperture in each of said nuts.

8. The assembly according to claim 4, wherein said respective eyebolt is movable toward or away from said tow ball when said respective eyebolt is adjusted in said nuts wherein said respective eyebolt is configured to align each of said apertures in outer wall of said tube with a pin hole in the drawbar thereby facilitating said pin to extend through the pin hole.

9. The assembly according to claim 8, wherein each of said eyebolts comprises a universal joint integrated into an eye of said eyebolt, said respective eyebolt threadably engaging said bounding edge of each of said nuts wherein said universal joint in said respective eyebolt is configured to pivotally engage the tow point.

10. A drawbar tow hitch assembly for attaching a tow ball to a draw bar of a tractor, said assembly comprising:
a tube having a passageway extending therethrough wherein said passageway is configured to have a drawbar of a tractor extended therethrough, said tube having a first end, a second end and an outer wall extending therethrough, said outer wall having a top side, a bottom side, a first lateral side and a second lateral side, said first lateral side having a first opening extending therethrough, said second lateral side having a second opening extending therethrough, said first opening being aligned with said second opening to define said passageway, each of said first opening and said second opening being positioned closer to said first end than said second end, said top side having a hole extending therethrough, said hole being positioned between said passageway and said first end, said tube having a pair of apertures each extending through a respective one of said top side and said bottom side, said apertures being aligned with each other, each of said apertures being aligned with said first opening and said second opening wherein each of said apertures is configured to be aligned with the drawbar when the drawbar is extended through said passageway;
a pin being extendable through said tube wherein said pin is configured to engage the drawbar for attaching said tube to the drawbar, said pin being extendable through each of said apertures in said top side and said bottom side of said outer wall;
a tow ball being removably attached to said tube wherein said tow ball is configured to facilitate the tractor to tow a trailer with a ball hitch when said tube is positioned on the drawbar, said tow ball including a screw that threadably engages a bounding edge of said hole in said top side of said outer wall of said tube;
a plurality of nuts, each of said nuts being attached to said tube, said nuts being aligned with each other on said tube, each of said nuts being positioned on said top side of said outer wall of said tube, said nuts being spaced apart from each other and being distributed from said second end toward said first end, each of said nuts having an aperture extending therethrough, said aperture in each of said nuts having a bounding edge, said bounding edge being threaded, said nuts being oriented such that an axis extending through said first end and said second end of said tube is aligned with an axis extending through said aperture in each of said nuts; and
a pair of eyebolts, a respective one of said eyebolts being adjustably attachable to said plurality of nuts wherein said respective eyebolt is configured to engage a tow point on the tractor, said respective eyebolt being movable toward or away from said tow ball when said respective eyebolt is adjusted in said nuts wherein said respective eyebolt is configured to align each of said apertures in outer wall of said tube with a pin hole in the drawbar thereby facilitating said pin to extend through the pin hole, each of said eyebolts comprising a universal joint integrated into an eye of said eyebolt, said respective eyebolt threadably engaging said bounding edge of each of said nuts wherein said universal joint in said respective eyebolt is configured to pivotally engage the tow point.
